(19) United States
(12) Patent Application Publication
(10) Pub. No.: US 2009/0084010 A1
(43) Pub. Date: Apr. 2, 2009

(54) Automobile advertisement attachment

(76) Inventor: David Rudolph Dykstra, Glendale, CA (US)

Correspondence Address: David R Dykstra, 1718 Arlington Ave #A, Glendale, CA, 91208, US

(21) Appl. No.: 11/906,339

(22) Filed: Oct. 2, 2007

(51) Int. Cl. G09F 21/04

(52) U.S. Cl. 40/591

(57) ABSTRACT

An enclosure attachment for storing, carrying, dispensing, protecting, displaying, and otherwise broadcasting general advertisement and communication including but not limited to business cards, restaurant menus, flyers, digital text displays, flat panel screens (e.g. LCDs), any other media, in the scope of being attached to any surface of an automobile.

### FIELD OF THE INVENTION

The present invention relates to creating an alternate method of utilizing the automobile as a means of advertising and communication.

### BACKGROUND OF THE INVENTION

One scope of the invention allows owners to make a paper advertisement available to people when the vehicle is parked. Also allowing the owner the ability to remove the compartment with ease when necessary. Many small business owners cannot find good ways of attracting customers. This is especially prevalent with Mom & Pop restaurants. Many times a new restaurant will arrive on the seen, but they have an out-of-the-way location and can remain obscure. This applies to many small businesses and self-employed persons.

The use of an automobile is already expensive enough, it's about time people made use of it as a means of advertising. Many means of auto advertisements already exist, but this one is unique in its function. An individual may have an inexpensive source of advertising by filling their Auto Ad Attachment with their own content to the end that it is available to passers-by. Easy attachment and removal are useful and necessary, considering many times people may attach this item to their trunk, so they obviously don't want the contents of the enclosure to fall out when they pop open their trunk or put down their tailgate.

On the other hand, when attaching a flat screen to your automobile, you may want to advertise on the road, but when parked, you could stow it away for safety.

### SUMMARY OF THE INVENTION

It is therefore an object of the present invention to provide an automobile advertisement enclosure that can be easily attached and detached.

It is also an object of the present invention to hold and make available dispensation of paper advertisements and communications when the automobile is parked.

It is a further object of the present invention to protect its contents from the elements.

It is a further object of the present invention to provide for easy insertion and removal of individually created content.

It is also an object of the present invention to display and present its content to passers-by.

These and other objects and advantages of the present invention will be apparent to those of ordinary skill in the art upon inspection of the detailed description, drawings, and appended claims.

The present invention comes assembled and can easily be attached to an automobile after it has been parked. Its functions primarily serve as opening and closing, while remaining attached to an automobile.

### BRIEF DESCRIPTION OF THE DRAWINGS

FIG. 1 shows an example of one version of the present invention as attached to a roughly diagrammed automobile.

FIG. 2 shows an example of a second version of the present invention as attached to a roughly diagrammed automobile.

FIG. 3 shows an example of a third version of the present invention as attached to a roughly diagrammed automobile.

FIG. 4 shows a detailed sample of the front view of the present invention design of FIG. 1.

FIG. 5 shows a detailed sample of the side view of the present invention design of FIG. 1.

FIG. 6 shows a detailed 3 dimensional view of the present invention design of FIG. 1.

FIG. 7 shows a detailed view of the lid and location of the hinges of the present invention design of FIG. 1.

FIG. 8 shows a detailed 3 dimensional view of the present invention design of FIG. 2.

FIG. 9 shows a detailed 3 dimensional view of the present invention design of FIG. 3.

FIG. 10 shows a detailed 3 dimensional view of the present invention design as it would be fashioned for the purpose of holding and dispensing business cards.

### DETAILED DESCRIPTION OF THE PRESENT INVENTION

FIG. 1 shows an example of the present invention as claim 1 purports. The casing is a simple cuboid designed to hold paper advertisements. It is designed to not interfere with performance or safety design of the automobile itself.

Attached to a vehicle in a parking lot, this attachment would be conspicuous and attract attention, especially if the contents are interesting. Passer-bys can freely “Take one” of the paper advertisements as prompted by the user's attaching the present invention to their vehicle. The present invention and its user-originated contents encourage passers-by to interact with it. It is the users responsibility to know that it will attract people to their vehicle, and that any activity, positive or negative, as a result of such people's attraction and/or interaction is their own right and responsibility. Any user or buyer of this item would understand this risk.

Any risk involved with operating an automobile while the present invention is affixed will be the responsibility of the user and/or operator. The present invention must not be interacted with while affixed to a moving vehicle.

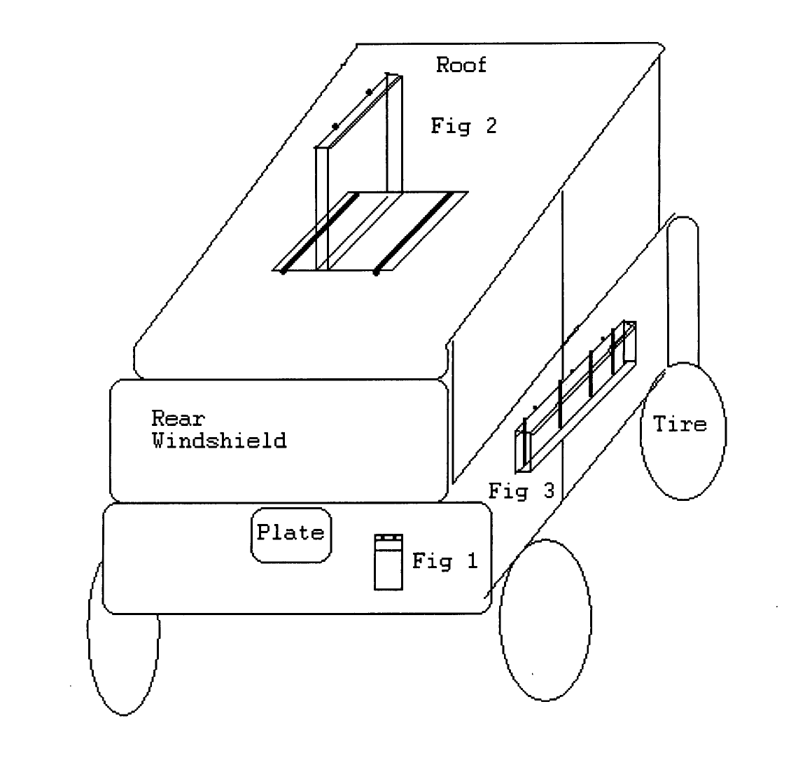

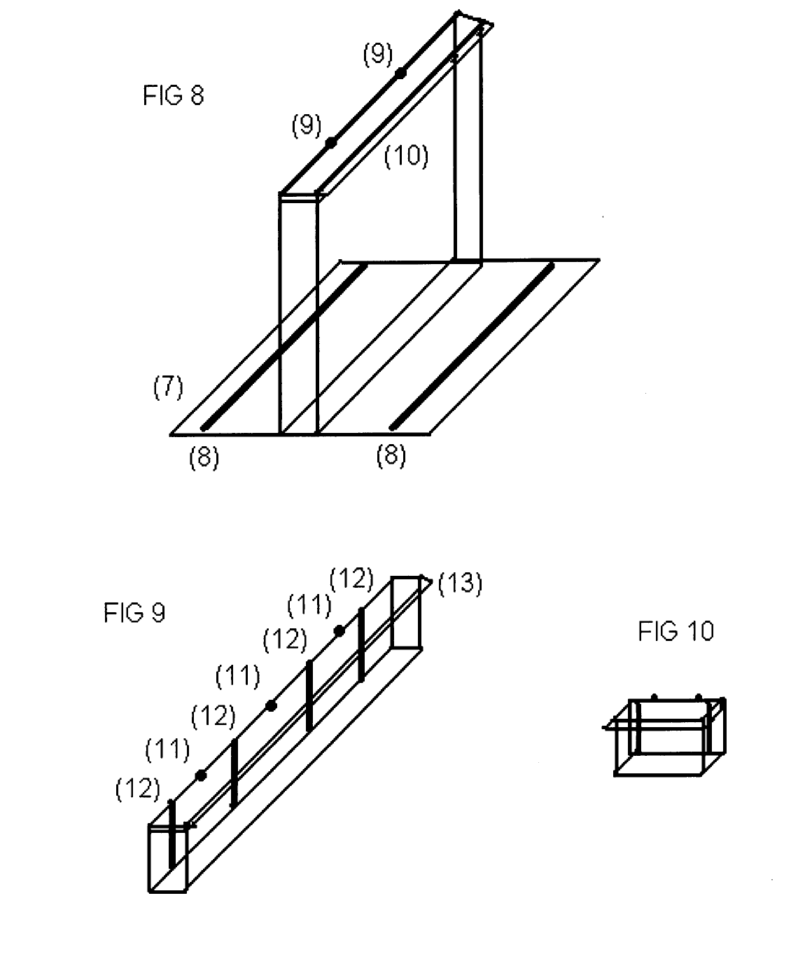

FIG. 2 shows an example of the present invention as claim 2 purports. The present invention is attached to an automobile and is clearly visible to passers-by. This is a step forward in the rooftop advertisements commonly seen atop taxis in bigger cities. An LCD screen with user originated content can be inserted and removed easily from the present invention, or an adhesive dampener could be applied to keep it closed. The present invention can be affixed or removed easily also. The thick black lines are high powered magnets, to assure the Auto Ad Attachment remains attached while the vehicle is moving. A more detailed look at this version is available in FIG. 8

Any risk involved with operating an automobile while the present invention is affixed will be the responsibility of the user and/or operator. The present invention must not be interacted with while affixed to a moving vehicle.

FIG. 3 shows an example of the present invention as claim 1 purports. Here it is attached to the side of the vehicle. It can easily be attached or removed as needed. The lid flips open and closed. A more detailed look at this version of the present invention is highlighted in FIG. 9.

Any risk involved with operating an automobile while the present invention is affixed will be the responsibility of the user and/or operator. The present invention must not be interacted with while affixed to a moving vehicle.

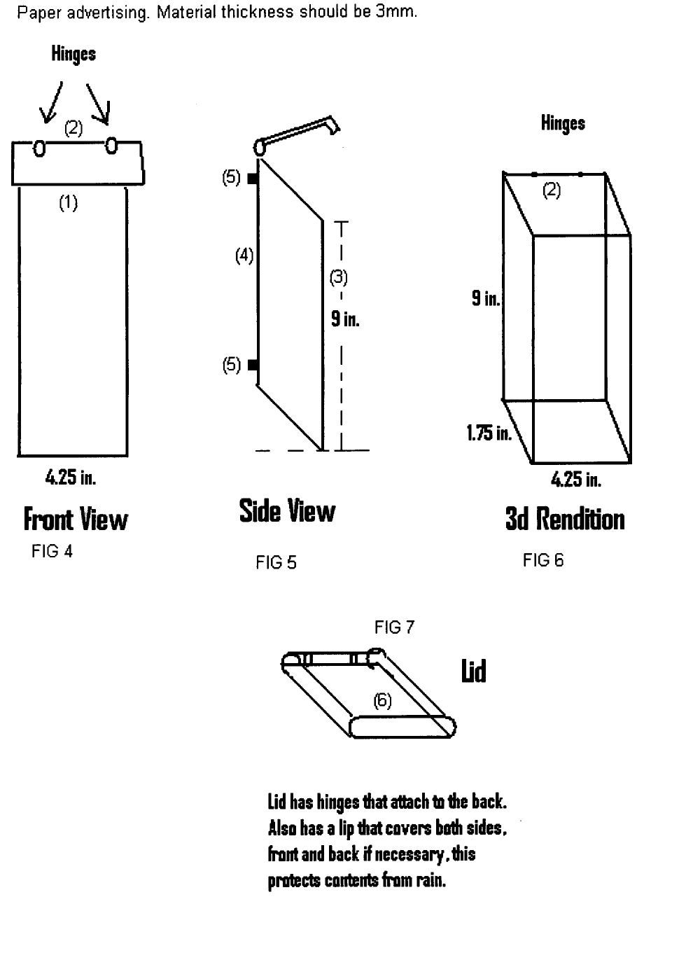

FIG. 4—A basic front view of the present invention casing design of FIG. 1. The casing may be made of stiff or semi-flexible material such as plastic or acrylic. The opening(l) is at the top, the hinges(2) are at back of the top of the lid. A basic rectangularly shaped casing.

FIG. 5 Side view of the present invention casing design of FIG. 1., 45 degree angle approx. slant from front(3) to back(4) encourages paper items to slide to the front, however any angle or lack thereof is optional. Black dots on the back denote magnets(5).

FIG. 6 A three dimensional depiction of the FIG. 1 casing design that would likely be used for paper ads and communications. The inlays of the hinges(2) are on the top back to attach to the lid. This particular cuboid structure has measurements of 9 inches×4.25 inches×1.75 inches, perfect casing for take-out restaurant menus.

FIG. 7 Lid has hinges that attach to the casing. Also has a lip to cover both sides, the front, and the back ensuring contents safety from the elements. A dampener may be applied to the inner part of the lid to dampen noise and collision with the casing. Also, a different dampener(6) may be applied to top of the lid to dampen slamming of the lid against vehicle exterior surfaces. Possible dampeners include rubber, felt, both, or other material.

FIG. 8 shows a closeup version of the present invention as claim 2 purports. Here we see the base(7) with magnets(8) running along the bottom of it represented by the thick black lines. It is one piece made of stiff or semi-flexible plastic or acrylic designed to carry a flat panel monitor on top of an automobile. At the top are two hinges(9) that serve to hold the lid(10), it flips open and closed. The design is a simple cuboid attached to the base version of the present invention. It's magnet will have to be of superior power to withstand high speeds of moving automobiles.

The magnets will have to be of superior power to stay attached to the vehicle while it is in motion. Any risk involved with operating an automobile while the present invention is affixed will be the responsibility of the user and/or operator. The present invention must not be interacted with while affixed to a moving vehicle.

FIG. 9 shows a closeup version of the present invention as claim 1 purports. Here we see the Automobile Advertisement Attachment is designed as a rectangular cuboid with hinges( 1) and a lid(13). Attached to the back are four magnets(12) It is long and slender and made of stiff or semi-flexible plastic or acrylic, this would be perfect for housing digital text displays. A good application of this version of the present invention would be affixed along one side of a vehicle covering one or more doors. Easy to load and unload with content, easy to attach and remove from the vehicle.

The magnets will have to be of superior power to stay attached to the vehicle while it is in motion. Any risk involved with operating an automobile while the present invention is affixed will be the responsibility of the user and/or operator. The present invention must not be interacted with while affixed to a moving vehicle.

FIG. 10 shows a design of the present invention as would appear for the purpose of dispensing business cards, per claim 1. It is smaller that the restaurant menu one, but follows all the same designed formula. The thick lines denote magnets on the back, the lid at the top is attached by hinges. A simple cuboid shape fabricated from plastic, acrylic, or other materials.

The magnets will have to be of superior power to stay attached to the vehicle while it is in motion. Any risk involved with operating an automobile while the present invention is affixed will be the responsibility of the user and/or operator. The present invention must not be interacted with while affixed to a moving vehicle.

What is claimed is:

1. An attachment compartment for a vehicle comprising:
a. An adhering back utilizing magnetic strips or adhesive
b. casing of any geometric shape, usually cuboid/rectangular cube
c. hinges connecting to the lid
d. a lid for opening and closing
e. a closing or dampening agent for the lid to cling to the compartment
opening, muffle noise, and/or maintain good condition of vehicle.
wherein said compartment stores modes of advertisement or communication wherein said adhering back attaches to and detaches from an exterior surface of a vehicle.

2. An attachment compartment for a vehicle of claim 1 where in the back:
a. Utilizes magnetic strips or adhesive
b. Casing protrudes in any geometric shape
c. Back operates as a foundation for the protruding casing
wherein said compartment stores modes of advertisement or communication wherein said adhering back attaches to and detaches from an exterior surface of a vehicle.
